(19) United States
(12) Patent Application Publication
(10) Pub. No.: US 2019/0269487 A1
(43) Pub. Date: Sep. 5, 2019

(54) Interdental Cleaning Element

(71) Applicant: M+C Schiffer GmbH, Neustadt/Wied (DE)

(72) Inventor: Marco Stock, Lahnstein (DE)

(21) Appl. No.: 16/320,179

(22) PCT Filed: Jul. 6, 2017
(86) PCT No.: PCT/EP2017/066897

§ 371 Date: Jan. 24, 2019

(30) Foreign Application Priority Data
Jul. 26, 2016 (EP) 16181277.1

(51) Int. Cl. A61C 15/04; A46B 3/18; A46B 9/06

(52) U.S. Cl. CPC A61C 15/046; A46B 3/18; A46B 2200/108; A61C 15/041; A46B 9/06

(57) ABSTRACT

The invention relates to an interdental cleaning element having a rod-like base and cleaning elements projecting substantially at right angles therefrom. The aim of the invention is to improve the cleaning action of the interdental cleaning element. This aim is achieved, according to the invention, in that first and second cleaning elements be fixed to the base, wherein the first cleaning element is a bristle element and the second cleaning element consists of a dental floss material, and wherein the rod-like base has wire elements twisted relative to one another, which clamp the first and second cleaning elements between themselves.

The present invention relates to an interdental cleaning element having a rod-like base and cleaning elements projecting substantially at right angles therefrom, wherein first and second cleaning elements be fixed to the base, the first cleaning element being a bristle filament made of stretched plastic, e.g. PA, PBT, PE, and PTFE and the second cleaning element consisting of a dental floss material. Such interdental cleaning element is known from U.S. Pat. No. 3,861,406 A.

U.S. Pat. No. 3,861,406 A relates to a toothbrush from which bristle filaments extend at right angles on one side of a rod-like base. On the other side of the rod-like base, a dental floss is stretched over two tine arms, which extend at right angles from the rod-like base. Thus, the toothbrush according to U.S. Pat. No. 3,861,406 A can be used with one side for brushing the teeth or the interdental space and with the other side for cleaning the interdental spaces using the dental floss.

The problem underlying the present invention is to provide an interdental cleaning element which is improved in terms of its cleaning performance.

In order to solve this problem, the present invention provides an interdental cleaning element with the features of claim 1. This interdental cleaning element has a rod-like base as is known per se, from which cleaning elements are projecting substantially at right angles. In the interdental cleaning element according to the invention, however, at least two different interdental cleaning elements are fixed to the base, namely at least one first and at least one second cleaning element. The first cleaning element is a conventional bristle filament. Said bristle filament usually consists of a stretched polyamide. The bristle filament can also be made of PBT. The bristle filament is a conventional filament, as it is commonly used on interdental cleaning elements today. Accordingly, it depends less on the material composition than on the fact that this filament is formed as a monofilament and is fixed individually or together with a few, regularly no more than four filaments jointly at a point in the longitudinal direction of the rod-like base.

The interdental cleaning element further has at least one second cleaning element. This second cleaning element consists of a dental floss. Nowadays, dental floss usually consists of plastics, thus, polyamide or polyethylene or silk, and can be waxed or unwaxed or provided with a PTFE coating. The dental floss sold today can also be impregnated with fluoride or peppermint flavor. Today's common dental floss materials can be used to realize the solution according to the invention. In contrast to bristle filaments, dental floss is not formed as a monofilament. Rather, the dental floss material used in the interdental cleaning element according to the invention is fixed as a thread to the rod-like base, whereby each of the threads is composed of a large number of individual superfine threads which are twisted or interwoven with each other, for example. Such a dental floss composed of superfine threads fans out during use so that the individual superfine threads of the dental floss material offer multiple contact surfaces in the interdental space when the interdental cleaning element is used, which act interdentally and thus lead to improved cleaning in the interdental spaces. The dental floss material can have an essentially rotationally symmetrical cross-section, as is common with dental floss today. However, it is also possible to use a ribbon-like thread material as dental floss material in the meaning of this invention, which has a rather elongated cross-section.

The interdental cleaning element according to the invention is characterized in that the rod-like base has wire elements twisted relative to one another, which clamp the first and second cleaning elements between themselves.

From DE 10 2012 002 499 A1, metal wires that are twisted relative to one another are known which include conventional filaments having found general use for the configuration of bristle bundles in toothbrushes. These bristle filaments are usually monofilaments made of a stretched material, regularly polyamide.

In the interdental cleaning element according to the invention, bristle filaments and cleaning elements made of dental floss material are usually arranged one behind the other in the longitudinal direction of the rod-like base. The rod-like base made of twisted wire elements creates receiving areas for the cleaning elements at discrete points between the twisted wire elements. This allows bristle filaments and cleaning elements made of dental floss material to be combined in one position. Thus, in an eye formed by the two twisted wire elements, at least one first cleaning element and at least one second element can be provided together. Between one and four first and between one and four second cleaning elements can be accommodated in a common eye. Additionally or alternatively, the first and second cleaning elements can also be accommodated in different eyes of twisted wire elements and accordingly spaced apart with respect to the longitudinal axis of the rod-like base.

Usually, the cleaning elements are first fixed to the rod-like base without any special contouring. Subsequently, the trimming of the cleaning elements, which essentially extend at right angles to the rod-like base, takes place. These are cut in such a way that the side view of the interdental cleaning element shows a certain contouring. The enveloping surface formed by the tips of the cleaning elements can be cylindrical, conical or truncated conical. Trimming does not necessarily have to be rotationally symmetrical. Preferably, however, such a rotationally symmetric trimming is realized.

It is self-evident that the dental floss in particular can be provided with substances known today, such as flavorings or a coating e.g. with fluorides or PTFE.

With regard to the attachment or fixing of the interdental cleaning element, it is possible to fall back on previously known configurations. Thus, the interdental cleaning element can form a grip area that can be held, for example, between the thumb and the index finger of a hand. Equally well, connecting surfaces for attaching the interdental cleaning element to the handle of an interdental toothbrush can be formed at the fixing side end facing away from the rod-like base.

1. An interdental cleaning element comprising a rod-shaped base and cleaning elements extending therefrom substantially at right angles, wherein first and second cleaning elements are secured to the base, the first cleaning element being a bristle filament consisting of stretched plastic selected from at least one of PA, PBT, PE, or PTFE and the second cleaning element consisting of a dental floss thread material, wherein the rod-shaped base comprises wire elements, which are twisted together and between which the first and second cleaning elements are clamped in position.

2. The interdental cleaning element according to claim 1, wherein, with respect to the longitudinal axis of the rod-shaped base, first and second cleaning elements are arranged on the same level.

3. The interdental cleaning element according to claim 1, wherein with respect to the longitudinal axis of the rod-shaped base, the first cleaning element is spaced apart from the second cleaning element.
